(19) United States
(12) Patent Application Publication
(10) Pub. No.: US 2018/0323597 A1
(43) Pub. Date: Nov. 8, 2018

(54) SYSTEM FOR COVERING AND PROTECTING BURIED PIPES OR CABLES

(71) Applicant: Yannick JOUBEAUX, Saint Marc Jaumegarde (FR)

(72) Inventor: Yannick JOUBEAUX, Saint Marc Jaumegarde (FR)

(21) Appl. No.: 15/773,133

(22) PCT Filed: Dec. 9, 2015
(86) PCT No.: PCT/FR2015/053397

§ 371 Date: May 2, 2018

(30) Foreign Application Priority Data
Dec. 19, 2014 (FR) 14/63032

(51) Int. Cl. H02G 9/02; F16L 1/11; F16B 5/06

(52) U.S. Cl. CPC H02G 9/025; F16L 1/11; F16B 37/043; F16B 5/0642; F16B 5/0628

(57) ABSTRACT

A system for covering and protecting buried pipes or cables including a plurality of covering and protection plates, and a plurality of assembling devices suitable for allowing adjacent covering and protection plates to be assembled at covering areas, where each assembling device has a first assembling member including a first bearing surface configured to bear against a first face of a covering and protection plate, and a first assembling portion configured to extend through a through-opening provided in a covering and protection plate; a second assembling member including a second bearing surface configured to bear against a second face of a covering and protection plate, and a second assembling portion configured to extend through a through-opening provided in a covering and protection plate, the second assembling portion being configured to cooperate with the first assembling portion so as to assemble two adjacent covering and protection plates; and a blocking member configured to block the first and second respective assembling portions in a relative assembly position.

### TECHNICAL FIELD

The present disclosure concerns a system for covering and protecting buried pipes or cables.

### BACKGROUND

In order to avoid the deterioration of buried pipes or cables during earthworks, it is known to use covering and protection systems drowned in the ground and disposed above the buried pipes or cables.

These covering systems allow, on the one hand, protecting the buried pipes or cables against the damage caused by the bucket of a power shovel, and on the other hand inform the operator of the presence of pipes or cables so that said operator does not dig deeper in this place.

A first known solution consists in providing a covering and protection system constituted of a reinforced concrete covering plate. This type of covering system has sufficient mechanical strength to protect buried pipes or cables against damage caused by the bucket of a power shovel.

However, a drawback of this type of covering plate lies in that it is heavy and cumbersome. As a result, said plate is difficult to handle.

Furthermore, the metal reinforcements incorporated in the reinforced concrete covering plate may interfere with the electrical or electromagnetic signals transmitted by a detection and identification device of buried elements, and therefore prevent a satisfactory spotting of the buried pipe by an operator.

A second known solution consists in providing a covering and protection system comprising a plurality of protective plates each including, at two opposite edges, complementary assembly means arranged to allow an assembly of two adjacent protective plates.

Advantageously, the complementary assembly means may be designed to allow a swiveling between two adjacent protective plates about an axis perpendicular to the extension planes of the protective plates. Such a covering and protection system thus allows adjusting the orientation between two adjacent protective plates, and therefore ensuring a protection continuity of the buried pipes or cables, including in curves.

The assembly means of the protective plates of such a system are generally made by snap-fastening, which makes it difficult, or even impossible, to separate two adjacent protective plates without deteriorating them, for example when it is necessary to access, in particular for maintenance reasons, to the pipes or pipelines disposed under said adjacent protective plates.

Furthermore, the assembly means provided on a protective plate are generally located in central portions of the respective edges of the respective protective plate. But, such an arrangement of the assembly means may damage the mechanical strength of a covering and protection system formed by a plurality of protective plates equipped with such assembly means.

### BRIEF SUMMARY

The present disclosure aims to overcome all or part of these drawbacks.

The technical problem underlying the disclosure consists, in particular, in providing a covering and protection system including assembly devices of covering and protection plates which are of simple and reliable structure, while ensuring reversible assembly of two adjacent covering and protection plates.

To this end, the present disclosure concerns a system for covering and protecting buried pipes or cables, comprising:
a plurality of covering and protection plates, each covering and protection plate having a first face and a second face opposite to the respective first face, and including a first end portion and a second end portion opposite to the respective first end portion, each covering and protection plate including at least one first assembly through-opening disposed on the first end portion of the respective covering and protection plate and opening respectively into the first and second faces of the respective covering and protection plate, and a second assembly through-opening disposed on the second end portion of the respective covering and protection plate and opening respectively into the first and second faces of the respective covering and protection plate, and
a plurality of assembly devices adapted to allow the assembly of adjacent covering and protection plates at the cover areas, each assembly device comprising:
   a first assembly member including a first bearing portion having a first bearing surface configured to bear against the first face of a covering and protection plate, and a first assembly portion configured to extend through a second assembly through-opening provided in a covering and protection plate,
   a second assembly member including a second bearing portion having a second bearing surface configured to bear against the second face of a covering and protection plate, and a second assembly portion configured to extend through a first assembly through-opening provided in a covering and protection plate, the second assembly portion of the second assembly member being configured to cooperate with the first assembly portion of the respective first assembly member so as to assemble, in use conditions, two adjacent covering and protection plates at a covering area,
   a blocking member configured to cooperate with at least one of the first and second assembly portions of the respective first and second assembly members so as to block the first and second assembly portions in a relative assembly position,

Such a configuration of each assembly device, and in particular the presence of the blocking member, ensures a reliable assembly of two adjacent covering and protection plates, while allowing an easy separation, without risk of deterioration, of the two covering and protection plates after removal of the blocking member.

The covering and protection system may further have one or more of the following features, taken alone or in combination.

According to an embodiment of the disclosure, each of the first and second assembly through-openings is configured to cooperate with at least one of the first and second assembly portions of the respective assembly device.

According to an embodiment of the disclosure, the first assembly portion of each first assembly member includes at least one elastically deformable assembly element comprising an outer assembly surface configured to cooperate with the second assembly portion of the respective second assembly member, and an inner bearing surface, each blocking member being configured to cooperate with the inner bearing surface of the at least one respective assembly element so as to immobilize the at least one assembly element in an assembly position in which the outer assembly surface of the at least one assembly element cooperates with the second assembly portion of the respective second assembly member. Such a configuration of the first assembly portion ensures an easy assembly of the first and second assembly portions of respective first and second assembly members.

According to an embodiment of the disclosure, the second assembly portion of each second assembly member includes an inner assembly surface configured to cooperate with the first assembly portion of the respective first assembly member, the inner assembly surface being annular and delimiting at least partially a receiving housing, the first assembly portion of each first assembly member being configured to be housed at least partially in the respective receiving housing.

According to an embodiment of the disclosure, the second assembly portion of each second assembly member is tubular.

According to an embodiment of the disclosure, the second assembly portion of each second assembly member includes an insertion opening leading into the respective receiving housing and through which the respective first assembly portion is intended to be introduced. Advantageously, the inner assembly surface converges in the direction of the insertion opening.

According to an embodiment of the disclosure, the second assembly member of each assembly device includes a passage opening leading into the respective receiving housing and intended for the passage of the respective blocking member.

According to an embodiment of the disclosure, the passage opening is disposed opposite to the respective insertion opening.

According to an embodiment of the disclosure, each assembly device further comprises a closing member configured to close the respective passage opening.

According to an embodiment of the disclosure, the at least one assembly element of each first assembly member is elastically deformable between an insertion position in which the respective first assembly portion is configured to be inserted into the respective receiving housing, and an assembly position in which the respective first assembly portion is configured to cooperate with the respective second assembly portion.

According to an embodiment of the disclosure, each blocking member is configured to cooperate with the inner bearing surface of the at least one respective assembly element so as to radially bias the at least one elastically deformable assembly element towards the assembly position thereof.

According to an embodiment of the disclosure, the first assembly portion of each first assembly member includes a plurality of elastically deformable assembly elements distributed about a longitudinal axis of the first assembly member.

According to an embodiment of the disclosure, the first assembly member of each assembly device includes at least one anchoring element configured to cooperate with a covering and protection plate so as to fasten, in use conditions, the first assembly member on said covering and protection plate.

According to an embodiment of the disclosure, the at least one anchoring element of each first assembly member is annular and is configured to cooperate with an inner surface delimiting the second assembly through-opening through which the respective first assembly portion is configured to extend.

According to an embodiment of the disclosure, the first assembly member of each assembly device includes a plurality of anchoring elements.

According to an embodiment of the disclosure, the first and second bearing surfaces of each assembly device are substantially flat.

According to an embodiment of the disclosure, the first and second bearing surfaces of each assembly device are annular.

According to an embodiment of the disclosure, the first assembly portion of each first assembly member extends from the respective first bearing portion. The first assembly portion of each first assembly member extends for example substantially perpendicularly relative to the respective first bearing surface.

According to an embodiment of the disclosure, the second assembly portion of each second assembly member extends from the respective second bearing portion. The second assembly portion of each second assembly member extends for example substantially perpendicularly relative to the respective second bearing surface.

According to an embodiment of the disclosure, the first assembly portion of each first assembly member includes a connecting part extending from the respective first bearing portion, the at least one respective anchoring member being provided on the connecting part.

According to an embodiment of the disclosure, the at least one elastically deformable assembly element of each first assembly member extend from the respective connecting part.

According to an embodiment of the disclosure, the at least one elastically deformable assembly element of each first assembly member is an elastically deformable assembly tab.

According to an embodiment of the disclosure, each blocking member has a substantially truncated-cone shape.

According to an embodiment of the disclosure, each blocking member includes an outer thread configured to cooperate with the respective first assembly portion.

According to an embodiment of the disclosure, each blocking member includes a proximal end comprising a rotational driving element configured to cooperate with a clamping tool so as to transmit a clamping torque to the blocking member.

According to an embodiment of the disclosure, each rotational driving element is a female imprint formed in the end face of the proximal end of the respective blocking member. The female imprint may for example be a hexagonal imprint or may have any other shape, such as a star shape. For example, a star shape of the imprint allows preventing a removal of the respective blocking member by an unauthorized operator, that is to say an operator who does not have an adapted clamping tool.

According to an embodiment of the disclosure, each covering and protection plate is substantially flat and is made of synthetic material in one piece part.

According to an embodiment of the disclosure, each covering and protection plate is substantially rectangular.

According to an embodiment of the disclosure, in which the first and second assembly members of each assembly device and the first and second assembly openings of each covering and protection plate are configured to enable, in an assembly position of two adjacent covering and protection plates, a swiveling of said covering and protection plates about a swivel axis substantially perpendicular to the extension planes of said covering and protection plates.

According to an embodiment of the disclosure, each first assembly opening is disposed in a central area of the respective first end portion, and each second assembly opening is disposed in a central area of the respective second end portion.

According to an embodiment of the disclosure, the first and second assembly members and the first and second assembly openings are configured to block, in use conditions, a relative movement of two adjacent covering and protection plates assembled to each other along the respective swivel axis.

According to an embodiment of the disclosure, each covering and protection plate further includes:
at least one circular-arc-shaped adjustment slot centered on the axis of the respective first assembly through-opening and disposed on the first end portion of the respective covering and protection plate, the at least one adjustment slot respectively opening into the first and second faces of the respective covering and protection plate and being configured to cooperate with at least one of the first and second assembly portions of a respective assembly device, and
at least one adjustment opening disposed on the second end portion of the respective covering and protection plate and opening respectively into the first and second faces of the respective covering and protection plate, the at least one adjustment opening of each covering and protection plate being configured to cooperate with at least one of the first and second assembly portions of a respective assembly device,

each assembly device and the at least one adjustment slot and the at least one adjustment opening of each covering and protection plate being configured so as to limit, in an assembly position of two adjacent covering and protection plates, the amplitude of adjustment of the swivel angle between said adjacent covering and protection plates.

According to an embodiment of the disclosure, each assembly device and the at least one adjustment slot and the at least one adjustment opening of each covering and protection plate are configured to limit, in an assembly position of two adjacent covering and protection plates, the amplitude of adjustment of the swivel angle between said covering and protection plates in a range of values comprised between 0° and 45°, and advantageously substantially comprised between 0° and 10°.

According to an embodiment of the disclosure, the at least one adjustment slot is configured to slidably receive the second assembly portion of an assembly device.

According to an embodiment of the disclosure, each covering and protection plate includes two circular-arc-shaped adjustment slots centered on the axis of the respective first passage through-opening and two adjustment openings equidistant relative to the respective second assembly through-opening.

According to an embodiment of the disclosure, the at least one adjustment opening is disposed in the vicinity of a corner of the respective covering and protection plate.

According to an embodiment of the disclosure, the first assembly portion of each first assembly member is configured such that in use conditions, the first assembly portion protrudes from the second face of a covering and protection plate.

According to an embodiment of the disclosure, the second assembly portion of each second assembly member is configured such that, in use conditions, the second assembly portion protrudes from the first face of a covering and protection plate.

According to an embodiment of the disclosure, the height of the first assembly portion of each first assembly member is greater than the thickness of a covering and protection plate.

According to an embodiment of the disclosure, the height of the second assembly portion of each second assembly member is greater than the thickness of a covering and protection plate.

According to an embodiment of the disclosure, the first and second assembly members of each assembly device are configured in such that, in the assembly area of two adjacent covering and protection plates, the two covering and protection plates are superimposed.

### BRIEF DESCRIPTION OF THE DRAWINGS

In any case, the disclosure will be well understood using the following description with reference to the appended schematic drawing representing, by way of non-limiting examples, several embodiments of this covering and protection system.

FIG. 1 is a top view of a covering and protection system according to a first embodiment of the disclosure;

FIG. 2 is a partial perspective view of the covering and protection system of FIG. 1;

FIG. 3 is a partial longitudinal sectional view of the covering and protection system of FIG. 1;

FIG. 4 is a perspective view of a first assembly member belonging to an assembly device of the covering and protection system of FIG. 1;

FIG. 5 is a perspective view of a second assembly member belonging to an assembly device of the covering and protection system of FIG. 1;

FIG. 6 is a perspective view of a blocking member belonging to an assembly device of the covering and protection system of FIG. 1;

FIGS. 7 and 8 are respectively top and bottom views of a covering and protection plate according to a second embodiment of the disclosure,

FIG. 9 is a partial perspective view of the covering and protection plate of FIG. 7, on an enlarged scale;

FIG. 10 is a perspective view, on an enlarged scale, of one of the protrusions extending over the first and second faces of the covering and protection plate of FIG. 7;

FIGS. 11 to 15 are top views of different covering and protection systems according to the disclosure,

FIG. 16 is a top view of a covering and protection plate according to a third embodiment of the disclosure.

### DETAILED DESCRIPTION

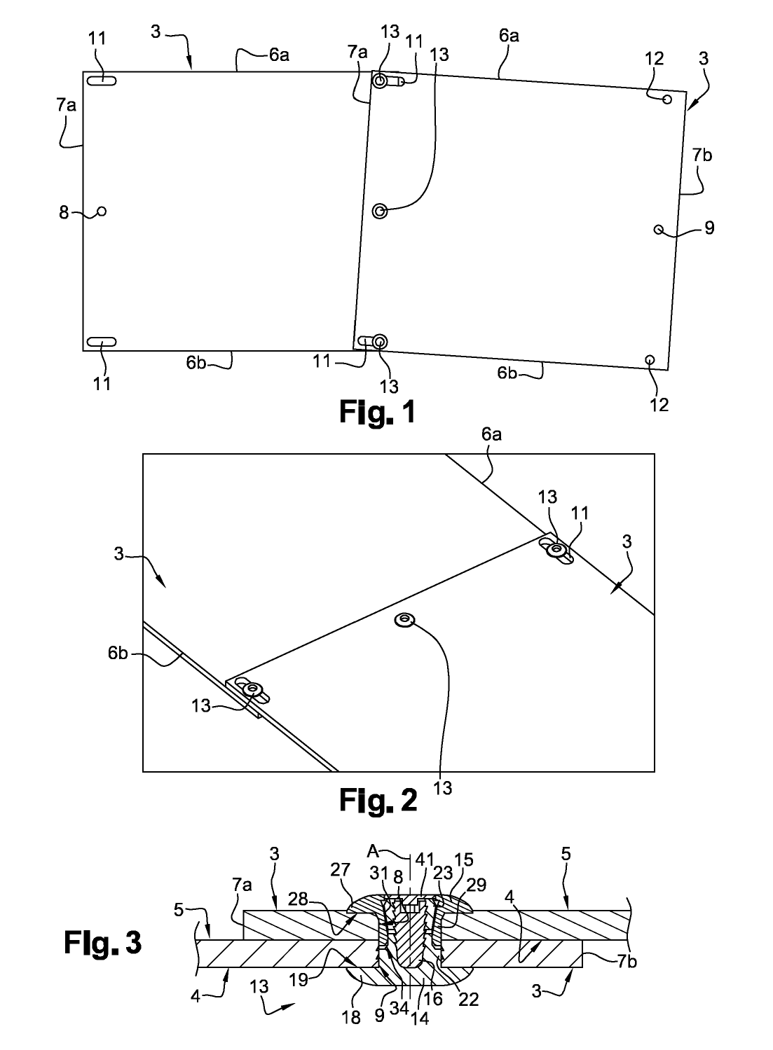

FIGS. 1 to 3 show a system for covering and protecting 2 buried pipes or cables, such as fluid transfer pipes or pipelines, or electrical or telecommunication cables. The covering and protection system 2 is arranged to ensure a protection continuity of the pipes or cables, including in the curves.

The covering and protection system 2 comprises a plurality of substantially flat and substantially rectangular covering and protection plates 3. Each covering and protection plate 3 has a first face 4 and a second face 5 opposite to the respective first face 4. Each covering and protection plate 3 is advantageously made of synthetic material in one piece part.

Each covering and protection plate 3 includes a first longitudinal edge 6a and a second longitudinal edge 6b opposite to the respective first longitudinal edge 6a, and a first transverse edge 7a and a second transverse edge 7b opposite to the respective first transverse edge 7a.

Each covering and protection plate 3 includes a first assembly through-opening 8 disposed in the vicinity of the first transverse edge 7a and in a central longitudinal portion of the respective covering and protection plate 3. The first assembly opening 8 opens respectively into the first and second faces 4, 5 of the respective covering and protection plate 3. Each covering and protection plate 3 further includes a second assembly through-opening 9 disposed in the vicinity of the second transverse edge 7b and in the central longitudinal portion of the respective covering and protection plate 3. The second assembly opening 9 opens respectively into the first and second faces 4, 5 of the respective covering and protection plate 3.

Each covering and protection plate 3 also includes two circular-arc-shaped adjustment slots 11 centered on the axis of the respective first assembly opening 8 and disposed in the vicinity of the respective first transverse edge 7a. Each adjustment slot 11 is a through-slot and opens respectively into the first and second faces 4, 5 of the respective covering and protection plate. The two adjustment slots 11 advantageously extend substantially in the vicinity respectively of the first and second longitudinal edges 6a, 6b of the respective covering and protection plate 3. Thus, each adjustment slot 11 is disposed in the vicinity of a corner of the respective covering and protection plate 3. According to an embodiment of the disclosure, each adjustment slot 11 extends over an angular sector comprised, for example, between 2 and 30°.

Each covering and protection plate 3 further includes two adjustment through-openings 12 equidistant relative to the second respective assembly opening 9, and disposed in the vicinity of the respective second transverse edge 7b. Each adjustment opening 12 opens respectively into the first and second faces 4, 5 of the respective covering and protection plate. The two adjustment openings 12 advantageously extend substantially in the vicinity respectively of the first and second longitudinal edges 6a, 6b of the respective covering and protection plate 3. Thus, each adjustment opening 12 is disposed in the vicinity of a corner of the respective covering and protection plate 3.

Advantageously, the distance between an adjustment opening 12 and the respective second assembly opening 9 is substantially identical to the distance between an adjustment slot 11 and the respective first assembly opening 8. Thus, during assembly of two adjacent covering and protection plates 3, the adjustment openings 12 of any of the covering and protection plates 3 are adapted to be disposed facing respectively adjustment slots 11 of the other covering and protection plate 3.

The covering and protection system 2 further comprises a plurality of assembly devices 13 adapted to allow the assembly of adjacent covering and protection plates 3 at the covering areas.

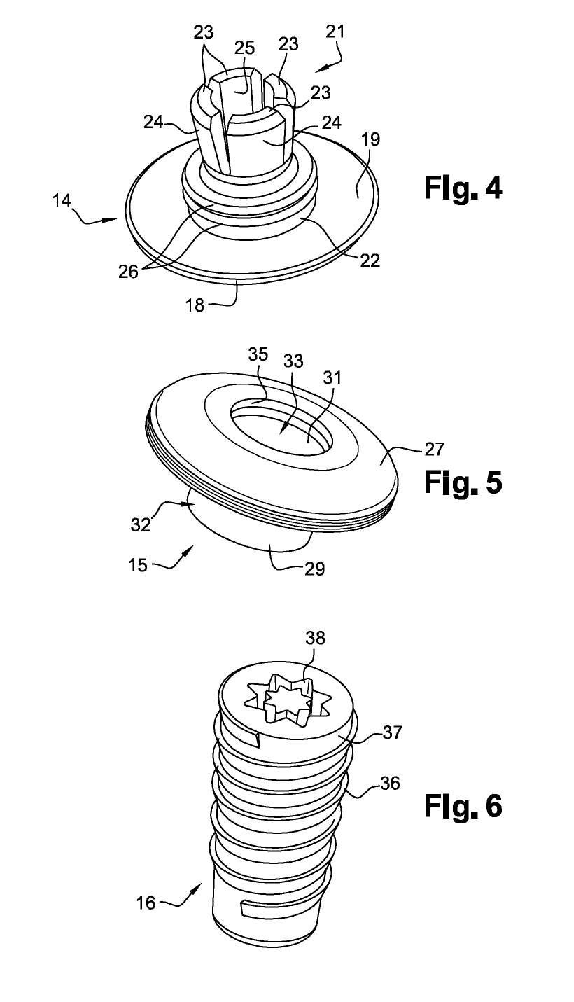

As shown more particularly in FIGS. 3 to 6, each assembly device 13 comprises in particular an assembly member 14, an assembly member 15 and a blocking member 16.

Each assembly member 14 includes a bearing portion 18 having a flat and annular bearing surface 19 and configured to bear against the first face 4 of a covering and protection plate 3. Each assembly member 14 further includes an assembly portion 21 configured to extend through the second assembly opening 9 of a covering and protection plate 3 and also to extend through an adjustment opening 12 of a covering and protection plate 3. Each assembly portion 21 extends for example substantially perpendicularly relative to the respective bearing surface 19.

The assembly portion 21 of each assembly member 14 includes a connecting part 22, for example annular, extending from the bearing portion 18, and a plurality of elastically deformable assembly elements 23 extending from the respective connecting part 22 and distributed about a longitudinal axis of the assembly member 14. Each assembly element 23 has the shape of an elastically deformable tab, and comprises an outer assembly surface 24 configured to cooperate with the assembly member 15 of the respective assembly device 13, and an inner bearing surface 25 configured to cooperate with the blocking member 16 of the respective assembly device 13.

According to the embodiment shown in the figures, the assembly portion 21 of each assembly member 14 has a height greater than the thickness of a covering and protection plate 3, and for example greater than twice the thickness of a covering and protection plate 3. Thus, as shown in FIG. 3, in the assembly position of two adjacent covering and protection plates 3, the assembly portion 21 extends through the assembly openings 8, 9 of the two covering and protection plates 3 and protrudes from the second face 5 of the upper covering and protection plate.

Each assembly member 14 further includes at least one anchoring element 26, for example annular, extending over the connecting part 22 and configured to cooperate with a covering and protection plate 3 so as to ensure, in use conditions, a main fastening of the respective assembly member 14 on the covering and protection plate 3. According to an embodiment of the disclosure, each assembly member 14 includes a plurality of anchoring elements 26, and for example, two anchoring elements 26, axially shifted.

As shown in FIG. 3, each anchoring element 26 is more particularly configured to cooperate with an annular inner surface delimiting an assembly opening 9 or an adjustment opening 12 of a covering and protection plate 3.

As shown in FIGS. 3 and 5, each assembly member 15 includes a bearing portion 27 having a flat and annular bearing surface 28 and configured to bear against the second face 5 of a covering and protection plate 3. Each assembly member 15 further includes a tubular assembly portion 29 configured to extend through the assembly opening 8 of a covering and protection plate 3 and also to extend through an adjustment slot 11 of a covering and protection plate 3. The assembly portion 29 of each assembly member 15 is more particularly configured to cooperate with the assembly portion 21 of a respective assembly member 14 so as to assemble, in use conditions, two adjacent covering and protection plates 3 at a covering area of said covering and protection plates. Advantageously, each assembly portion 29 extends coaxially with the respective annular bearing surface 28.

Each assembly portion 29 includes an annular inner assembly surface 31 and is configured to cooperate with the outer assembly surfaces 24 of the assembly elements 23 of a respective assembly member 14. Each assembly portion 29 also includes an outer surface 32 configured to cooperate, for example by friction, with an annular inner surface delimiting the assembly opening 8 of a covering and protection plate 3. When the assembly member 15 is inserted into an adjustment slot 12, the outer surface 32 is, on the contrary, configured to slidably cooperate with the inner wall delimiting said adjustment slot 12.

Advantageously, the inner assembly surface 31 partially delimits a receiving housing 33 in which the assembly elements 23 of a respective assembly member 14 are intended to be housed at least partially.

Each assembly portion 29 also includes an insertion opening 34 opening into the receiving housing 33 and through which the assembly elements 23 of the respective assembly member 14 are intended to be introduced. Advantageously, the inner assembly surface 31 converges in the direction of the insertion opening 34.

The assembly elements 23 of each assembly member 14 are more particularly elastically deformable between an insertion position in which the assembly elements 23 are brought closer to each other and are configured to be inserted into the receiving housing 33 of the respective assembly member 15 via the insertion opening 34 of the said assembly member, and an assembly position in which the assembly members 23 are spaced apart from each other and are configured to cooperate with the inner assembly surface 31 of the respective assembly member 15.

Each assembly member 15 further includes a passage opening 35 intended for the passage of the blocking member 16. The passage opening 35 is advantageously disposed opposite to the insertion opening 34 and opens into the receiving housing 33. The assembly members 14, 15 are advantageously configured such that, in use conditions, the passage opening 35 opens opposite to an inner volume delimited by the respective assembly elements 23, and in particular opposite to the free ends of the assembly elements 23.

According to the embodiment shown in the figures, the assembly portion 29 of each assembly member 15 has a height greater than the thickness of a covering and protection plate 3. Thus, as shown in FIG. 3, in the assembly position of two adjacent covering and protection plates 3, the assembly portion 29 of an assembly member 15 protrudes from the first face 4 of the upper covering and protection plate.

As shown in FIGS. 3 and 6, each blocking member 16 has a substantially truncated-cone shape and includes an outer thread 36 configured to cooperate with the assembly portion 21 of the respective assembly member 14. Each blocking member 16 includes a proximal end 37 comprising a rotational driving element 38 configured to cooperate with a clamping tool so as to transmit a clamping torque to the blocking member 16. According to the embodiment shown in the figures, the rotational driving element 38 is formed by a female imprint formed in the end face of the proximal end 37 of the respective blocking member 16. The female imprint may be for example a hexagonal imprint or may have any other shape, such as a star shape.

Each blocking member 16 is more particularly configured to cooperate with the inner bearing surfaces 25 of the assembly elements 23 of the respective assembly member 15 so as to radially bias the assembly elements 23 towards the assembly position thereof and/or so as to immobilize the assembly elements 23 in the assembly position thereof. Each blocking member 16 is therefore configured to block the assembly portions 21, 29 of the respective assembly members 14, 15 in a relative assembly position.

Each blocking member 16 can be inserted into the volume delimited by the respective assembly elements 23, for example by screwing or also by impaction.

According to the embodiment shown in FIG. 3, each assembly device further comprises a closing member 41 configured to close the passage opening 35, and thereby preventing a filling of the female imprint 38 of the respective blocking member 16 likely to preventing a subsequent unscrewing of the blocking member 16. The closing member 41 may have, for example, a male imprint configured to cooperate, for example by friction, with the female imprint of the respective blocking member 16.

As shown in FIGS. 1 and 2, three assembly devices 3 are advantageously used to carry out the assembly of two adjacent covering and protection plates 3, a first assembly device 3 being inserted into the adjacent assembly openings 8, 9 of said covering and protection plates 3, a second assembly device 3 being inserted into one of the adjustment slots 11 and one of the adjustment openings 12 of said covering and protection plates 3, and a third assembly device 3 being inserted into the other of the adjustment slots 11 and the other of the adjustment openings 12 of said covering and protection plates 3.

As shown more particularly in FIGS. 1 and 2, the assembly members 14, 15 of each assembly device 13 and the first and second assembly openings 8, 9 of each covering and protection plate 3 are configured to enable, in an assembly position of two adjacent covering and protection plates 3, a swiveling of said covering and protection plates 3 about a swivel axis A substantially perpendicular to the extension planes of said covering and protection plates, and to block, in use conditions, a relative movement of said covering and protection plates along the respective swivel axis.

Furthermore, the assembly members 14, 15 of each assembly device 13 and the adjustment slots 11 and the adjustment openings 12 of each covering and protection plate 3 are configured to limit, in an assembly position of two adjacent covering and protection plates 3, the amplitude of adjustment of the swivel angle between said covering and protection plates.

According to an embodiment of the disclosure, the assembly members 14, 15 of each assembly device 13 and the adjustment slots 11 and the adjustment openings 12 of each covering and protection plate 3 are configured to limit, in an assembly position of two adjacent covering and protection plates 3, the amplitude of adjustment of the swivel angle between said covering and protection plates in a range of values comprised between 0° and 45°, and advantageously comprised substantially between 0° and 10°.

A method of covering and protecting a pipe, for example gas or liquid pipe, by a covering and protection system 2 according to the disclosure will be now described.

The covering and protection method comprises the following steps comprising:

a) making a trench in the ground using a mechanical earth working device,

b) laying the pipe in the trench,

c) covering the pipe with a layer of soil,

d) positioning a covering and protection plate 3 in the trench substantially horizontally above the pipe,

e) fastening assembly members 14 respectively in the assembly opening 9 and in each of the adjustment openings 12 of the covering and protection plate 3 positioned beforehand,

f) positioning a new covering and protection plate 3 in the trench substantially horizontally above the pipe such that the assembly portions 21 of the three assembly members 14 fastened on the covering and protection plate 3, positioned beforehand, extend respectively in the adjustment slots 11 and the assembly opening 8 of the new covering and protection plate 3,

g) making the assembly portions 29 of three assembly members 15 cooperate respectively with the assembly portions 21 of the assembly members 14 fastened on the covering and protection plate 3 positioned beforehand,

h) adjusting the swivel angle between the two adjacent covering and protection plates 3,

i) repeating steps e) to h) several times so as to form a row of covering and protection plates 3 disposed one after the other, long enough to completely cover the pipe.

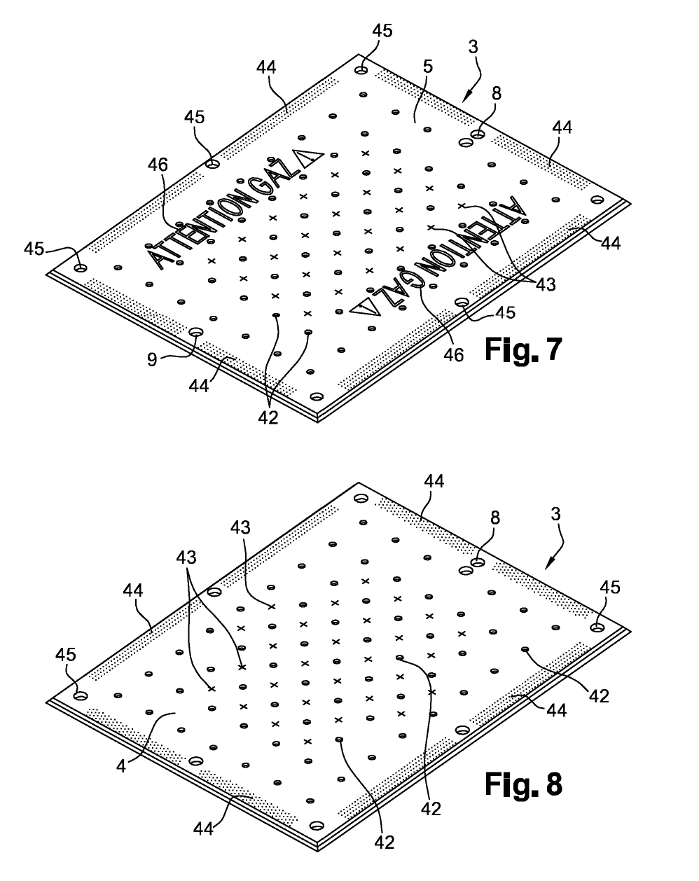

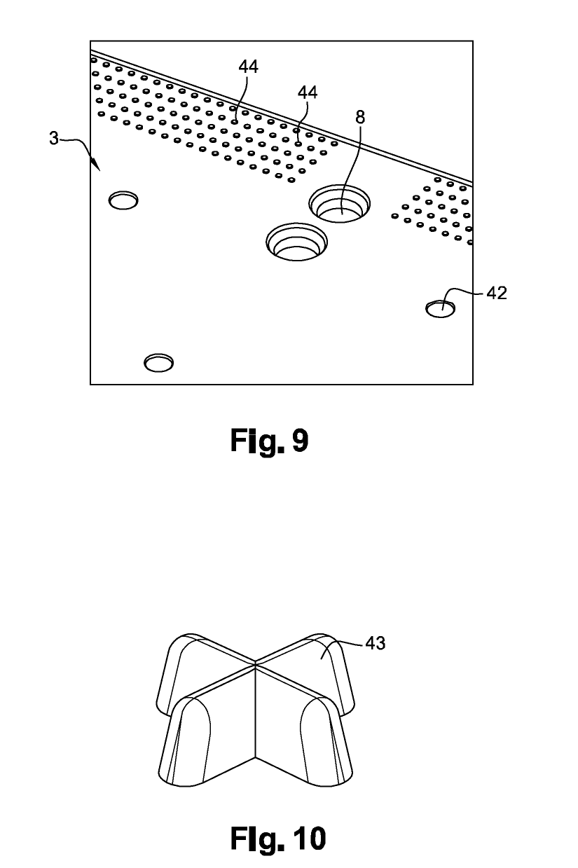

FIGS. 7 to 10 show a covering and protection plate 3 according to a second embodiment of the disclosure.

According to this second embodiment of the disclosure, the covering and protection plate 3 further comprises a plurality of through-orifices 42 opening respectively into the first and second faces 4, 5 of the covering and protection plate 3, the through-orifices 42 being advantageously distributed regularly over the covering and protection plate 3. Each through-orifice 42 preferably extends substantially perpendicularly to the plane of the covering and protection plate 3.

According to this second embodiment of the disclosure, the first and second faces 4, 5 of the covering and protection plate 3 include, on at least one part of their surface, protrusions 43 for example substantially cross-shaped, the protrusions 43 being advantageously distributed regularly over each face 4, 5 of the covering and protection plate 3.

According to this second embodiment of the disclosure, the covering and protection plate 3 also comprises gripping means formed at each of the edges thereof. The gripping means preferably include a plurality of studs 44 extending substantially perpendicularly from the first and second faces 3, 4 of the plate.

According to this second embodiment of the disclosure, the adjustment slots 11 and the adjustment openings 12 are replaced by assembly through-openings 45 disposed at the corners of the covering and protection plate 3 and each one is configured to cooperate with at least one of the first and second assembly portions of an assembly device 13. The covering and protection plate 3 may further comprise assembly through-openings 45 in the vicinity of the longitudinal edges thereof and in a transverse central portion of a covering and protection plate 3.

Advantageously, the first face 4 of the covering and protection plate 3 includes means for identifying the buried pipes or cables, the identification means being preferably markings 46 printed on the second face 5 of the covering and protection plate 3.

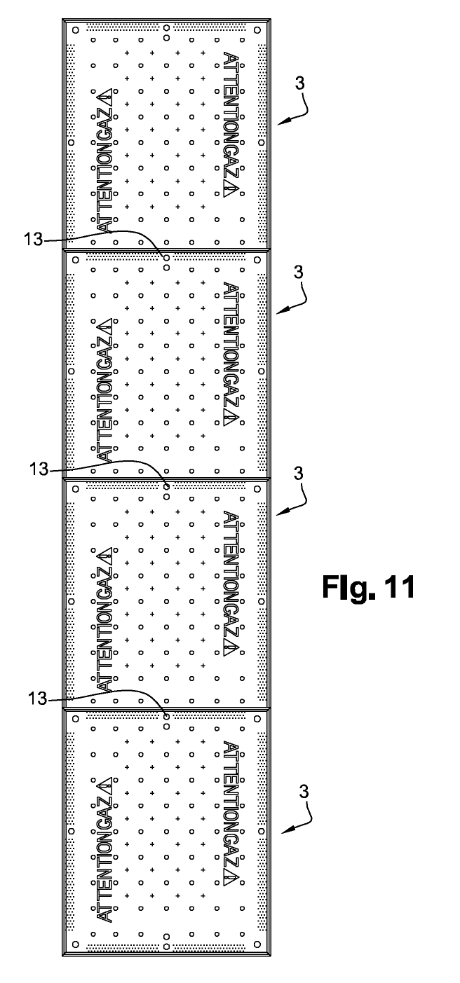

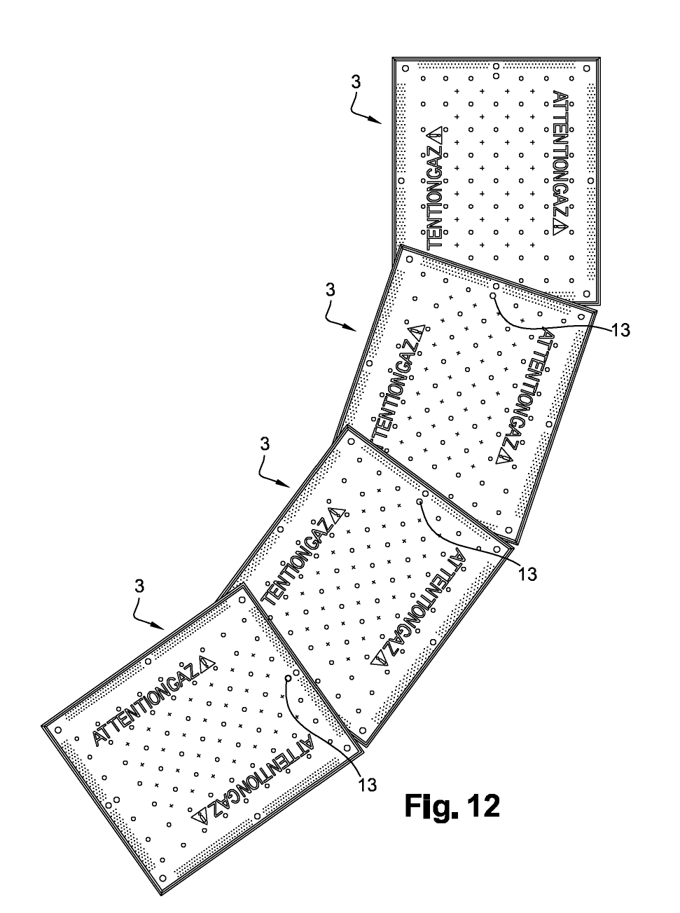

FIGS. 11 to 15 show covering and protection systems 2 obtained by implementing different methods of covering and protection using covering and protection plates 3 according to the second embodiment of the disclosure. The covering and protection systems 2 of FIGS. 11 and 12 are obtained, for example, by implementing a method of covering and protection similar to the method previously described.

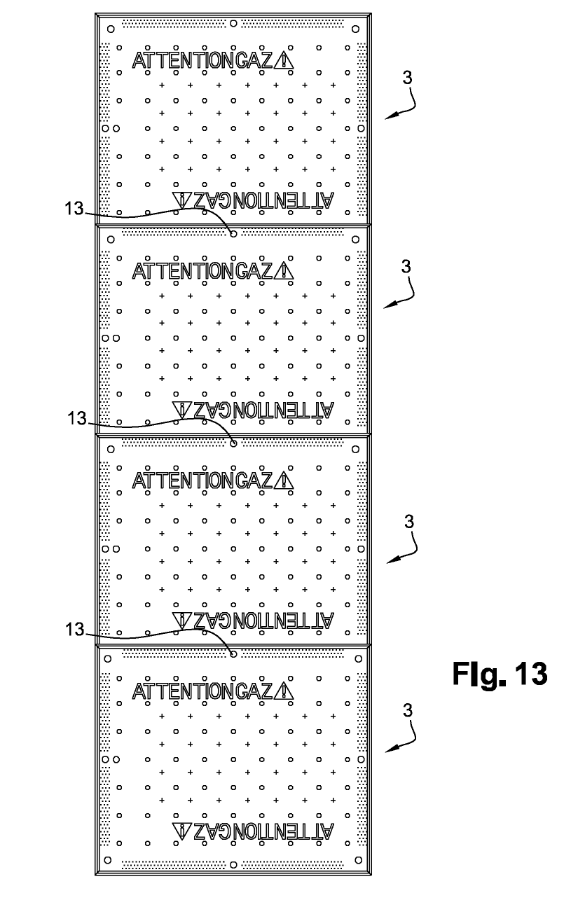

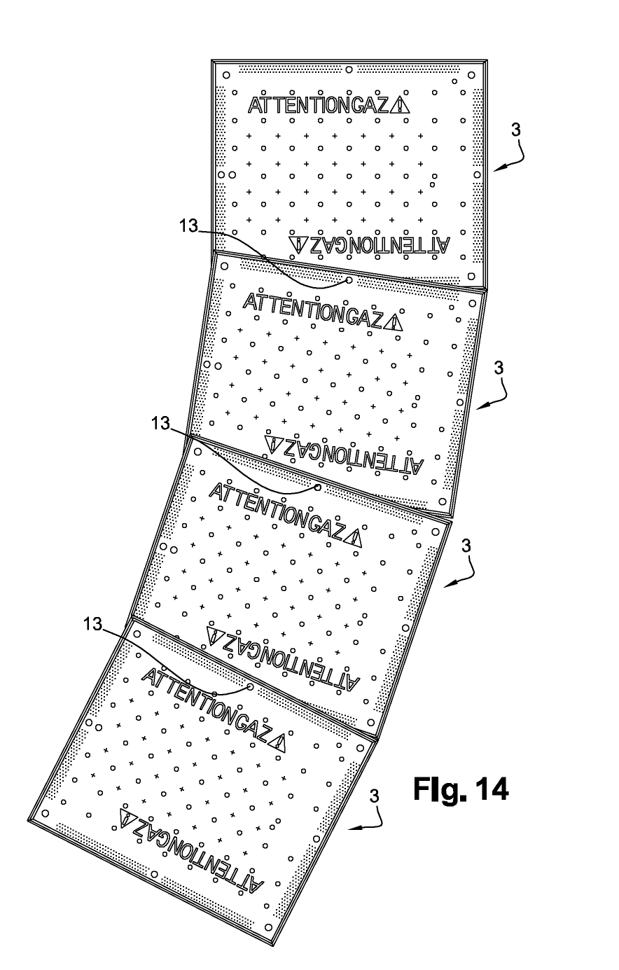

The covering and protection systems 2 of FIGS. 13 and 14 are obtained more particularly by assembling covering and protection plates 3 using assembly devices 13 inserted into the assembly openings 45 disposed at the longitudinal edges of the covering and protection plates 3.

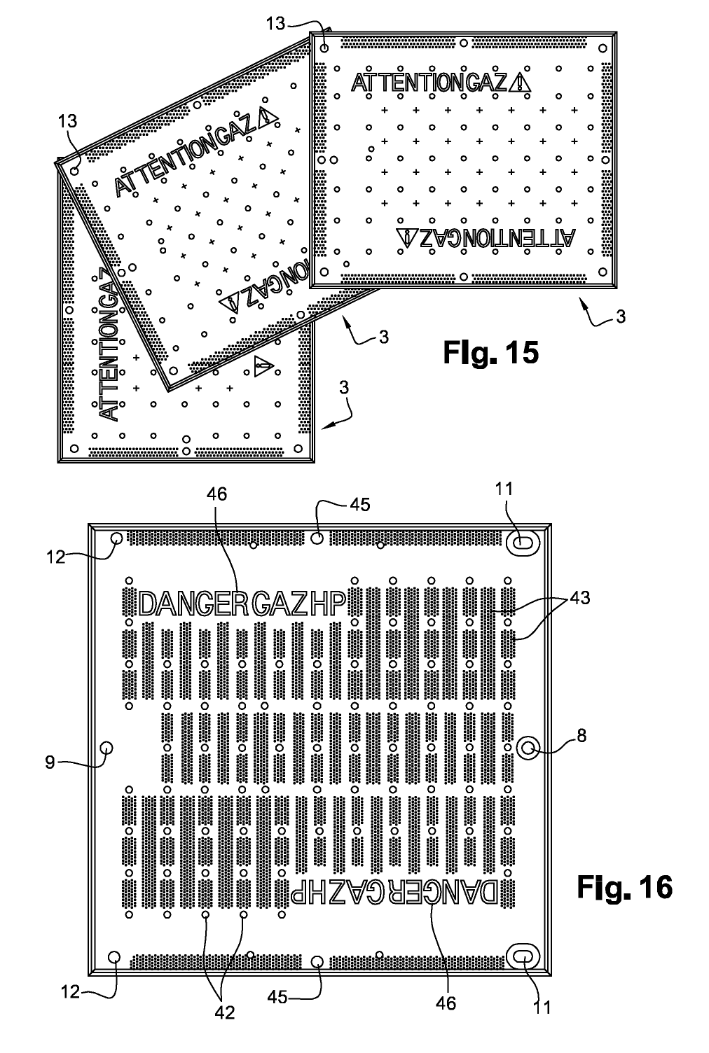

The covering and protection system 2 of FIG. 15 is obtained more particularly by assembling covering and protection plates 3 using assembly devices 13 inserted in the assembly openings 45 disposed at the corners of the covering and protection plates 3.

FIG. 16 shows a covering and protection plate 3 according to a third embodiment of the disclosure which differs from the embodiment shown in FIGS. 7 to 10 essentially in that the covering and protection plate 3 is provided with two adjustment slots 11 and two adjustment openings 12.

Of course, the disclosure is not limited to the sole embodiments of this covering and protection system 2, described above by way of examples, it encompasses, on the contrary, all variants.

1. A system for covering and protecting buried pipes or cables, comprising:
a plurality of covering and protection plates, each covering and protection plate having a first face and a second face opposite to the respective first face, and including a first end portion and a second end portion opposite to the respective first end portion, each covering and protection plate including at least one first assembly through-opening disposed on the first end portion of the respective covering and protection plate and opening respectively into the first and second faces of the respective covering and protection plate, and a second assembly through-opening disposed on the second end portion of the respective covering and protection plate and opening respectively into the first and second faces of the respective covering and protection plate, and
a plurality of assembly devices adapted to allow the assembly of adjacent covering and protection plates at cover areas, each assembly device comprising:
a first assembly member including a first bearing portion having a first bearing surface configured to bear against the first face of a covering and protection plate, and a first assembly portion configured to extend through a second assembly through-opening provided in a covering and protection plate,
a second assembly member including a second bearing portion having a second bearing surface configured to bear against the second face of a covering and protection plate, and a second assembly portion configured to extend through a first assembly through-opening provided in a covering and protection plate, the second assembly portion of the second assembly member being configured to cooperate with the first assembly portion of the respective first assembly member so as to assemble, in use, two adjacent covering and protection plates at a covering area,
a blocking member configured to cooperate with at least one of the first and second assembly portions of the respective first and second assembly members so as to block the first and second assembly portions in a relative assembly position.

2. The covering and protection system according to claim 1, wherein the first assembly portion of each first assembly member includes at least one elastically deformable assembly element comprising an outer assembly surface configured to cooperate with the second assembly portion of the respective second assembly member, and an inner bearing surface, each blocking member being configured to cooperate with the inner bearing surface of the at least one respective assembly element so as to immobilize the at least one assembly element in an assembly position in which the outer assembly surface of the at least one assembly element cooperates with the second assembly portion of the respective second assembly member.

3. The covering and protection system according to claim 2, wherein the first assembly portion of each first assembly member includes a plurality of elastically deformable assembly elements, distributed around a longitudinal axis of the first assembly member.

4. The covering and protection system according to claim 1, wherein the second assembly portion of each second assembly member includes an inner assembly surface configured to cooperate with the first assembly portion of the respective first assembly member, the inner assembly surface being annular and delimiting at least partially a receiving housing, the first assembly portion of each first assembly member being configured to be housed at least partially in the respective receiving housing.

5. The covering and protection system according to claim 2, wherein the at least one assembly element of each first assembly member is elastically deformable between an insertion position in which the respective first assembly portion is configured to be inserted into the respective receiving housing, and an assembly position in which the respective first assembly portion is configured to cooperate with the respective second assembly portion.

6. The covering and protection system according to claim 4, wherein the second assembly member of each assembly device includes a passage opening emerging in the respective receiving housing and intended for the passage of the respective blocking member.

7. The covering and protection system according to claim 6, wherein each assembly device further comprises a closing member configured to close the respective passage opening.

8. The covering and protection system according to claim 1, wherein each blocking member includes an outer thread configured to cooperate with the respective first assembly portion.

9. The covering and protection system according to claim 1, wherein each blocking member includes a proximal end comprising a rotational driving element configured to cooperate with a clamping tool so as to transmit a clamping torque to the blocking member.

10. The covering and protection system according to claim 1, wherein the first assembly member of each assembly device includes at least one anchoring element configured to cooperate with a covering and protection plate so as to fasten, in use, the first assembly member on said covering and protection plate.

11. The covering and protection system according to claim 1, wherein the first and second assembly members of each assembly device and the first and second assembly openings of each covering and protection plate are configured to enable, in an assembly position of two adjacent covering and protection plates, a swivelling of said covering and protection plates about a swivel axis (A) substantially perpendicular to the extension planes of said covering and protection plates.

12. The covering and protection system according to claim 11, wherein each covering and protection plate further includes:
at least one adjustment slot having a circular arc shape, centered on the axis of the respective first assembly through-opening and disposed on the first end portion of the respective covering and protection plate, the at least one adjustment slot opening respectively into the first and second faces of the respective covering and protection plate and being configured to cooperate with at least one of the first and second assembly portions of a respective assembly device, and
at least one adjustment opening disposed on the second end portion of the respective covering and protection plate and opening respectively into the first and second faces of the respective covering and protection plate, the at least one adjustment opening of each covering and protection plate being configured to cooperate with at least one of the first and second assembly portions of a respective assembly device,
each assembly device and the at least one adjustment slot and the at least one adjustment opening of each covering and protection plate being configured so as to limit, in an assembly position of two adjacent covering and protection plates, the amplitude of adjustment of the swivel angle between said adjacent covering and protection plates.
